(19) United States
(12) Patent Application Publication
(10) Pub. No.: US 2008/0082408 A1
(43) Pub. Date: Apr. 3, 2008

(54) Method and system for awarding cash

(76) Inventor: Roland Santa Ana, Rockville, MD (US)

Correspondence Address: MAXVALUEIP CONSULTING, 11204 ALBERMYRTLE ROAD, POTOMAC, MD, 20854, US

(21) Appl. No.: 11/536,082

(22) Filed: Sep. 28, 2006

(51) Int. Cl. G06Q 30/00

(52) U.S. Cl. 705/14

(57) ABSTRACT

This system or method relates to the cash award directly awarded to the users of products and services, based on purchase, use, or other activities. The cash or cash equivalent are used here, such as e-check or regular check. The user's (participant's) authentication and fraud prevention are applied here. This is a way of advertisement for a product, service, or manufacturer, which encourages more use of a specific brand or product. It also relates to the cash award for viewing ads, based on click or other metrics. Here, for this system, the cash award is intended for the ad viewer, not the web site that displays the ad. It also applies to the rental or subscription models or situations.

### BACKGROUND

This disclosure relates to the cash award directly awarded to the users of products and services, based on purchase, use, or other activities. It also relates to the cash award for viewing ads, based on click or other metrics.

Note that these are different from the prior art, such as method of iwon.com (giving prizes). These are also very different from coupon-based, mileage-based, discount-based (e.g. one-step transaction discount), redemption-based, or direct-cash-back-from-manufacturer models, applied elsewhere in the industry. For example, these are different from cashback.com or creditcard.com models.

### SUMMARY

This disclosure relates to the cash award directly awarded to the users of products and services, based on purchase, use, or other activities. The cash or cash equivalent are used here, such as e-check or regular check. The user's (participant's) authentication and fraud prevention are applied here. This is a way of advertisement for a product, service, or manufacturer, which encourages more use of a specific brand or product. It also relates to the cash award for viewing ads (or topics, products, services, or Internet sites), based on click or other metrics. Here, for this system, the cash award is intended for the ad viewer, not the web site that displays the ad. This is the difference with the prior art.

### BRIEF DESCRIPTION OF THE DRAWINGS

FIG. 1 describes an embodiment of the current disclosure, in which a participant or user is awarded cash, with the system employing authentication and fraud prevention modules.

FIG. 2 describes an embodiment of the current disclosure, in which the relationship between different parties is shown, for example, for viewing ad situation.

### DETAILED DESCRIPTION OF THE PREFERRED EMBODIMENTS

One of the embodiments of this disclosure deals with a system for awarding cash or cash equivalents to a user for using or purchasing an object, product, or service. The user uses or purchases an object, product (e.g. car), or service offered by a first entity (e.g. a car manufacturer, such as Ford Corp.).

In this case, the user is registered with a second entity (let's call it “OurCorp”, such as a portal or web site). The system here is based on the business model of OurCorp. The user is authenticated for the submission of information, and OurCorp awards cash or cash equivalents to the user for using or purchasing the object, product, or service.

Another embodiments of this disclosure deals with a system for awarding cash or cash equivalents to a user for viewing an ad or causing the execution of a computer code, corresponding to said first entity, such as Ford Corp. The user is registered with the second entity (OurCorp), and OurCorp awards cash or cash equivalents to said user for viewing said ad or causing the execution of said computer code.

In this case, the first entity may or may not be the same as the second entity. That is, the Ford Corp. can own (or be the same as) OurCorp. Or, they can operate independently.

In one embodiment, the user is registered with said second entity for a fee, or for free. In one embodiment, the user registered with said second entity accepts an agreement with OurCorp, related to rules and obligations for users. In one embodiment, the limitations or rules include age and residency requirement for the user, plus conditions of purchase or use, mandated by the manufacturer. In one embodiment, the rules also prohibit the misuse or abuse of the system by the user.

In one embodiment, the cash equivalents comprise one or more of the following: e-check, check, certified-check, cashier's check, wired money, direct deposit, money order, precious metal coins, regular coins, or anything similar. But they do not include coupons, after-purchase-manufacturer's refund, mileage for airlines, points on credit card purchases, or similar concepts.

The examples of the products are: a car, an appliance, an electronic product, and a house. In one embodiment, the user uses the products. In one embodiment, the user purchases the products. In one embodiment, the user uses a product based on a rental or lease agreement. In one embodiment, the user uses a product based on a subscription agreement.

In one embodiment, the user views one or more of the following: TV, cable TV, satellite TV, multimedia on-line, DVD player, video, portable wireless media (e.g. channel selection and paid programs), games, and computer monitor. In one embodiment, the user listens to one or more of the following: radio, satellite radio, music, instructional programs, tape recorder, CD player, and iPod. In one embodiment, the user reads one or more of the following: magazine, newspaper, book, journal, Internet content, e-mail, entertainment publications (puzzles), directories, and newsletter.

In one embodiment, the system uses an encryption method to protect the data from hackers. PKI (public key infrastructure) technology and symmetric keys can be used for this purpose. In one embodiment, the system collects users' profiles, from the registration data and from the use and purchasing habits and patterns, to analyze, data-mine, and aggregate, for marketing purposes.

In one embodiment, the marketing or cross-marketing is done for the products or services in the same class or category, for which a potential user may benefit from or use/purchase, using correlation factors, statistical analysis, and past patterns, history, or data. For example, if somebody buys expensive cars, most likely, he or she is interested in expensive houses and clothing. Thus, if OurCorp is representing specific brands for clothing (in its pool of the brands, already signed up with OurCorp, as a member brand or preferred/ member manufacturer), OurCorp will ask the user if the user is also interested in (or already using) the member brand or member manufacturer, to encourage to join or use that brand.

Alternatively, OurCorp will collect the user's information, if the user has already joined or used the product, and desires to get paid by OurCorp, according to the rules and conditions set by the manufacturer. The marketing or correlation (analyzed or raw) data is very valuable to the manufacturers and service providers (or their storefronts), for marketing and sales predictions. This would be another source of income for OurCorp.

Cross-marketing within the OurCorp's pool of merchandise and services would benefit both user's experience (e.g. it is more convenient, and it saves time for the user) and merchant's sale (increase the sales volume). The corresponding sales commission/percentage/co-marketing/cross-marketing would be yet another source of income for OurCorp.

Within this cross-marketing scheme, in one embodiment, one can assign a point/credit account for different merchandise/services/brands/manufacturers/parent companies. For example, if brand (or item) A attracts the user to the OurCorp web site, and brand A causes the launch of brand B and other brands, then brand A gets a positive point for each occurrences. This point-accounting system makes it fair to deal with different brands, because it assigns relative importance and value for each brand, in terms of attractiveness for the users (and visitors of the OurCorp web site). In return, OurCorp can treat brand A favorably, in terms of rate, percentage, or subscription. For example, OurCorp charges brand A less money (or give other benefits) for the inclusion/participation in the product pool that the OurCorp web site is managing.

In one embodiment, the system uses one or more of the following to verify the authenticity of the user's identity, usage, or proof of purchase: RFID, GPS (for the position of the car or product, for tracking purposes), bar code, watermarking, biometrics, password, smart card, and magnetic card. In addition, the serial number, specific text (e.g. from a book or magazine, from a specific section of passage or text), or number on a product can be used for the verification that the user has a legitimate and original copy of the product. For example, the user may be asked to open the book to page 132, and type in the second letter, of the first word, of the second paragraph, to prove that the user has the possession of the book. Of course, this is not hacker-proof, but when combined with other methods, it makes it harder or more expensive to cheat the system, discouraging hackers. The usage or viewing can be traced by user's click on screen. A software module traces the clicks to prevent any abuse of the click counts by the hackers. For example, the one-click on a specific item or button on screen (to get into a web site or see an ad/banner (or do a search), through OurCorp) is monitored for abuse/fraud-detection/double-awarding. The clicks may be interpreted differently in different situations (e.g. depending on the traffic of the web and time of the day). Multiple clicks can also be used for authentication purposes (such as entering a password). The spams are also filtered by the system.

In one embodiment, verification of the use can be done with manufacturer and/ or with OurCorp, through their web sites, for example. The manufacturer can reduce its ad budget and funnel some of the fund to OurCorp, to encourage the use of its brand through OurCorp's cash awards to the users.

In one embodiment, people watch TV (specific channel, ad, or program), and the use/watching is monitored or verified by technologies already in the market, such as the methods used by Arbitron Ratings, to find the percentages and absolute numbers for viewers in each category.

Other examples of products/services are: cable TV usage, U-Tube kind of service, shoe, books, lawn maintenance, house maintenance, janitorial service, mechanic shop, cell phone user, movies (tickets), car rental, vacation package, transportation, participating stock market, auction, future investment, financial report, Internet auction, insurance, loans, business, travel, hotel, cruise, real estate, house, land, commercial, ad (e.g. ad words, ad sense, or questions, offered by other services on the Internet), games, software, music, downloadable content, consumer products, utility, gifts, bartering, investment, reselling, saving deposits, public or club membership, grocery, pharmaceuticals, contributions, funding, warranty, book clubs, shipping, insurance, or sport events.

Other examples of products/services are: computer-cell phone combinations, viewing an internet site, video ad, viewing TV channels or programs, video commercial, PDA, hybrid devices, music, camcorder, mobile video, mobile TV, TIVO, links, blogs, sound, mobile advertising, cell phone video downloads, podcast, web feeds, text message marketing, or WI-FI. For example, the use or purchase of any of the products/ services above can be the trigger for the cash award.

The manufacturers can pay for the search words, order of listed results, or bidding auction.

In one embodiment, generally, the more usage, the more cash award, up to a cap or maximum, as an absolute number, or dollar per week/month/year, for example. This is monitored and enforced strictly by the authentication/verification module, to make sure no hacker abusing the system or the reward program. This is done by the registration of the user, verification of identity, and proof of use, purchase, or possession. One way to limit the abuse is to have a unique ID, email, or serial number (e.g. Vehicle Identification Number). The history and user's profile are stored by OurCorp.

In one embodiment, there are different levels of user's participation, e.g. Platinum/Gold/Silver/Basics levels. The users are also rated based on their trust level and past transactions. A Preferred Merchant gets more prominent placement and gets priority in cross-marketing. The user information matches the products offered for targeted ads. In one embodiment, the user waives some of his privacy data, by participation in the cash award program, using an on-line contract between the user and OurCorp.

In one embodiment, the manner of use and usage (quality and quantity) are defined by the manufacturer. For example, the usage may be limited to original purchasers, only, based on the manufacturer's preference.

In one embodiment, the manufacturer pays for marketing data and analysis (patterns and user's habits), and OurCorp does not get paid anything to compensate the cash awards to the users. However, in another embodiment, OurCorp gets paid for (or corresponding to) every (or some/ percentage of) cash awards to the users.

In one embodiment, the award cash is connected to the game played by the user. In one embodiment, the user displays a logo or trademark of the manufacturer, as a walking advertisement on a T-shirt, or on a car, and the user get paid for that application or usage, by OurCorp, after proper proof and authentication. In one embodiment, the consumer report for the products evaluation and the credit report for the user are tied in the portal or web site of OurCorp, for better and complete service (to evaluate and exchange information, to offer various products and services, all in one place). In one embodiment, the user's account has two sections for history and preference files, to match to the categories of items and services, and OurCorp supplies questionnaire to the user to add to the user's profile. In one embodiment, the clicks are based on one click or based on multiple clicks on an ad or on an item on screen.

### DETAILED DESCRIPTION OF THE DRAWINGS

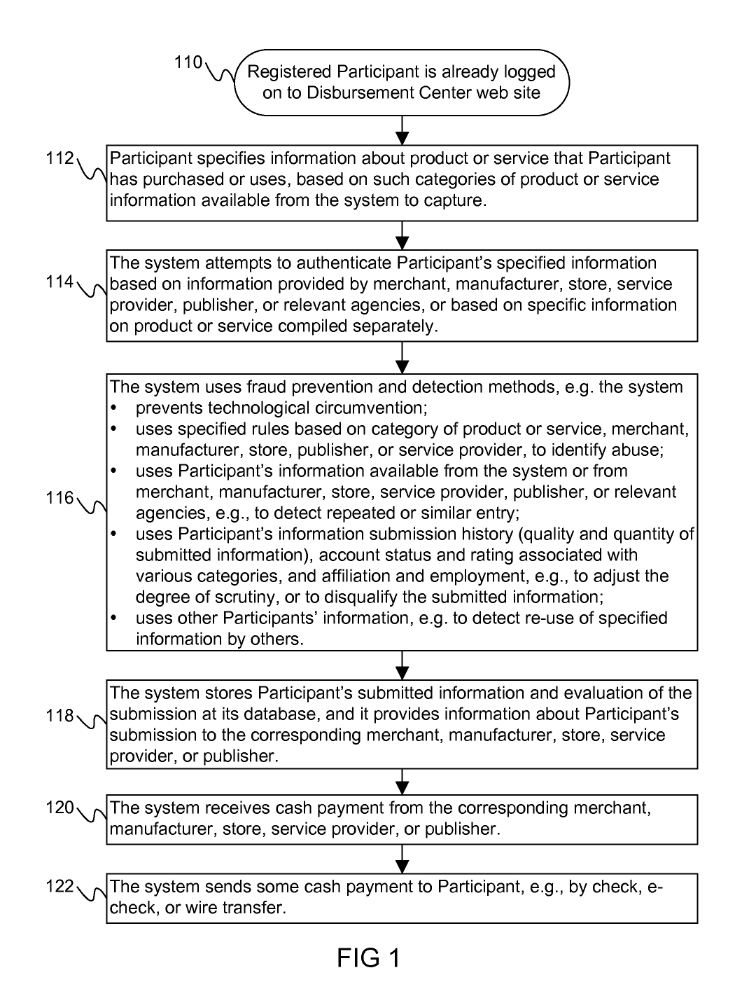

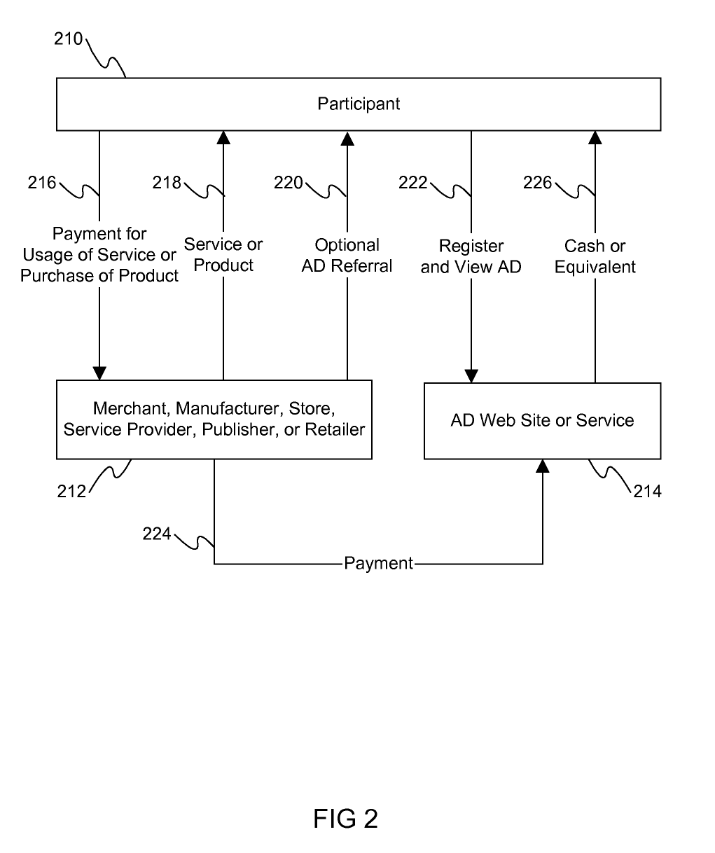

In FIGS. 1 and 2, we look at some examples or embodiments of this disclosure.

In FIG. 1, it shows how (an example) a system works. In item 110, Registered Participant is already logged on to the Disbursement Center web site (OurCorp).

In item 112, Participant specifies information about product or service that Participant has purchased or uses, based on such categories of product or service information available from the system to capture.

In item 114, the system attempts to authenticate Participant's specified information based on information provided by merchant, manufacturer, store, service provider, publisher, or relevant agencies, or based on specific information on product or service compiled separately.

In item 116, the system uses fraud prevention and detection methods, e.g. the system:
prevents technological circumvention;
uses specified rules based on category of product or service, merchant, manufacturer, store, publisher, or service provider, to identify abuse;
uses Participant's information available from the system or from merchant, manufacturer, store, service provider, publisher, or relevant agencies, e.g., to detect repeated or similar entry;
uses Participant's information submission history (quality and quantity of submitted information), account status and rating associated with various categories, and affiliation and employment, e.g., to adjust the degree of scrutiny, or to disqualify the submitted information; and/or
uses other Participants' information, e.g. to detect re-use of specified information by others.

In item 118, the system stores Participant's submitted information and evaluation of the submission at its database, and it provides information about Participant's submission to the corresponding merchant, manufacturer, store, service provider, or publisher.

In item 120, the system receives cash payment from the corresponding merchant, manufacturer, store, service provider, or publisher.

In item 122, the system sends some cash payment to Participant, e.g., by check, e-check, or wire transfer.

In FIG. 2, some of the relationship between parties is shown, as an example (between participant (210), merchant (212), and ad web site (214, or OurCorp)).

In items 216 and 218, service/ product is purchased by the user from merchant. There is an optional step of referral to ad web, from merchant to participant (220). Merchant pays ad web for its services (224), and ad web pays participant in cash (226) based on participant registration to view ads from ad view (222).

Some other variations of FIG. 2 deal with the usage or purchase of the items or services, instead of viewing ads.

In addition, any other variation of all of the above teaching is also intended to be covered by this patent application.

1. A system for awarding cash or cash equivalents to a user for using or purchasing an object, product, or service, said system comprising:
a first entity, and
a second entity,
wherein said first entity is different from said second entity,
wherein said user uses or purchases an object, product, or service offered by said first entity,
wherein said user is registered with said second entity,
wherein said user is authenticated for the submission of information, and
wherein said second entity awards cash or cash equivalents to said user for using or purchasing said object, product, or service.

2. A method for awarding cash or cash equivalents to a user for using or purchasing an object, product, or service, said method comprising the steps of:
said user using or purchasing an object, product, or service offered by a first entity,
wherein said user is registered with a second entity,
wherein said first entity is different from said second entity,
wherein said user is authenticated for the submission of information, and
said second entity awarding cash or cash equivalents to said user for using or purchasing said object, product, or service.

3. A system for awarding cash or cash equivalents to a user for viewing an ad or Internet site, searching topics, products, services, Internet sites, or ads, or causing the execution of a computer code, said system comprising:
a first entity, and
a second entity,
wherein said user views an ad, searches ads, or causes the execution of a computer code corresponding to said first entity,
wherein said user is registered with said second entity, and
wherein said second entity awards cash or cash equivalents to said user for viewing an ad, searching ads, or causing the execution of a computer code.

4. A system as recited in claim 3, wherein said first entity is the same as said second entity.

5. A method for awarding cash or cash equivalents to a user for viewing an ad or Internet site, searching topics, products, services, Internet sites, or ads, or causing the execution of a computer code, said method comprising the steps of:
said user viewing an ad, searching ads, or causing the execution of a computer code corresponding to a first entity,
wherein said user is registered with a second entity, and
said second entity awarding cash or cash equivalents to said user for viewing an ad, searching ads, or causing the execution of a computer code.

6. A method as recited in claim 5, wherein said first entity is the same as said second entity.

7. A system as recited in claim 1, wherein said user is registered with said second entity for a fee.

8. A system as recited in claim 1, wherein said user is registered with said second entity for free.

9. A system as recited in claim 1, wherein said user registered with said second entity accepts an agreement with said second entity.

10. A system as recited in claim 1, wherein said cash equivalents comprise one or more of the following: e-check, check, certified-check, cashier's check, wired money, direct deposit, direct pay, and money order.

11. A system as recited in claim 1, wherein said user purchases one or more of the following: a car, an appliance, an electronic product, and a house.

12. A system as recited in claim 1, wherein said user uses one or more of the following: a car, an appliance, an electronic product, and a house.

13. A system as recited in claim 1, wherein said user uses a product based on a rental or financial agreement.

14. A system as recited in claim 1, wherein said user views one or more of the following: TV, cable TV, satellite TV, DVD player, video, video ad, camcorder, mobile TV, TIVO-type service, mobile video, mobile advertising, cell phone video download, specific TV channel or program, video commercial, hybrid devices, computer/ cell phone combinations, and computer monitor.

15. A system as recited in claim 1, wherein said user listens to one or more of the following: radio, satellite radio, sound, music, podcast, tape recorder, CD player, and iPod.

16. A system as recited in claim 1, wherein said user reads one or more of the following: magazine, newspaper, book, journal, PDA, web feeds, blog, text message marketing, Internet content, e-mail, and newsletter.

17. A system as recited in claim 1, wherein said user uses a product based on a subscription agreement.

18. A system as recited in claim 1, wherein said system uses an encryption method.

19. A system as recited in claim 1, wherein said system collects users' profiles.

20. A system as recited in claim 1, wherein said system analyzes marketing or cross-marketing data.

21. A system as recited in claim 1, wherein said system uses one or more of the following: RFID, GPS, bar code, biometrics, password, smart card, and magnetic card.

22. A system as recited in claim 1, wherein said system uses one or more of the following: wireless connection, WI-FI, wired connection, electrical connection, telephone lines, Internet connection, computer network, intranet, cable, cellular network, and satellite transmission.

23. A system as recited in claim 1, wherein said system uses one or more of the following: downloadable games, code-activating games, and interactive media.

24. A system as recited in claim 1, wherein said system uses a transactional security software.

25. A system as recited in claim 1, wherein said user is awarded for displaying or using of an ad, brand, or trademark.

26. A system as recited in claim 1, wherein said system uses one or more of the following: consumer reports, financial reports, and credit reports.

27. A system as recited in claim 1, wherein said user is awarded for using one or more Internet links.

28. A system as recited in claim 1, wherein said system uses one or more of the following: rental automobiles, hotels, and residential buildings.

29. A system as recited in claim 1, wherein said system uses one or more of the following: financial instruments, mortgage loans, stock markets, funds, futures, consumer loans, and insurance.

30. A system as recited in claim 1, wherein said system uses one or more of the following: paid search words, ordering the results, and bidding on ads.
